(19) United States
(12) Patent Application Publication
(10) Pub. No.: US 2014/0365519 A1
(43) Pub. Date: Dec. 11, 2014

(54) INTELLIGENT PROCESSING OF USER INPUT TO A BUSINESS INTELLIGENCE SOFTWARE APPLICATION

(71) Applicant: Targit A/S, Hjorring (DK)

(72) Inventors: Morten MIDDELFART, Tampa, FL (US); Bue LAU, Hjorring (DK); Jan KROGSGAARD, Hjorring (DK)

(21) Appl. No.: 13/914,495

(22) Filed: Jun. 10, 2013

(51) Int. Cl. G06F 17/30

(52) U.S. Cl. CPC G06F 17/30477
USPC 707/769

(57) ABSTRACT

A computer-implemented method of processing an input via a user interface of a business intelligence software application for a database, wherein the software applications performs: listening for a user's input, and processing said input while it is received to identify input elements thereof; said input elements comprising at least a first and a second input element; searching among the executable functions for a named executable function that matches the first identified input element; searching in the set of named metadata items for matching metadata items that match the second identified input element; eliminating predefined patterns that do not match the named executable function and matching metadata items while keeping the matching ones; assigning a matching metadata item to one or more matching executable functions in the first predefined patterns according to its/their syntax; and selecting a pattern among the kept ones of predefined patterns and executing the function named in the selected predefined pattern with assigned metadata.

### BACKGROUND

1. Field

The technical field is business intelligence software applications.

Data processing for analytical or other purposes such as monitoring or reporting generates results which are presented graphically/visually to a user. Thereby the user is able to interpret the results and make decisions based on them.

Conventional software applications in this field requires two main steps to be performed by the user, firstly, defining a query to get a set of data retrieved from a database and then, secondly, defining a graphical presentation of those data retrieved from the database. Typically, the presentation means are selected by a user from a so-called ‘report generator’ or a ‘chart wizard’, wherefrom default layout properties or user specified layout properties are selected before making the presentation.

It is observed that conventional business intelligence software applications require close conformance to formal syntax—typically since data from an underlying database requires a very high degree of syntactical correct queries. Such close conformance to formal syntax was generally accepted and reflected in the way input from a user had to be entered. Also, it is observed that business intelligence software applications are configured with user interfaces that guides the user directly to a presentation of data, often via a so-called wizard.

2. Description of the Related Art

US 2004/230585-A discloses a method and a user interface for making a presentation of data using meta-morphing. It is mentioned that a user can enter a natural language question, like the following questions, via the user interface:

1) I would like to see ‘cost’ grouped by ‘time, month’
2) I would like to see ‘revenue’ grouped by ‘time, month’, ‘customer, group’ and ‘product, name’
3) I would like to see ‘revenue’
4) I would like to see ‘country’

Such a question is forwarded to a data determination unit, which is arranged to identify metadata items by parsing the question. Based on the identified metadata items, the data determination unit is able to look up a storage memory of previously used combinations of metadata which is used as an entry to retrieve previously used presentation properties that has been used in combination with the identified metadata items at an earlier occasion.

This gave some flexibility in the way a user could request a presentation of data. However, the options provided to a user in phrasing a question like the above ones were basically limited to possible combinations of measures, dimensions and criteria.

It is observed that today there is an even greater demand for a greater freedom in phrasing what a user wants to do with requested data. Especially, there is a sub-ordinate, but important demand that this greater freedom in phrasing what a user wants to do with requested data is provided with as few user interactions as at all possible. In fact, if a user perceives a user interface to be too rigid in its way of accepting input it may be a reason for discarding a business intelligence software application.

Conventionally a user compared different business intelligence software applications based on what features or functions the software application provides. Today, even if all the functions that a user needs are present, the user increasingly considers how smoothly and quickly the application gets you to a desired end-result.

### BRIEF SUMMARY

Thus, there is an unmet demand for providing, on the one hand, yet more functions in data analysis in business intelligence software applications while, on the other hand, enabling more direct access to a desired end-result.

There is provided a computer-implemented method of processing an input via a user interface of a business intelligence software application, wherein the software applications performs: listening for a user's input, and processing said input while it is received to identify input elements thereof; said input elements comprising at least a first and second input element; searching among predefined named executable functions for a matching executable function that match the first identified input element; searching in a predefined set of named metadata items for a matching metadata item that match the second identified input element; eliminating, from a set of syntax patterns with syntactically valid combinations of named executable functions and types of metadata, patterns that do not comprise the matching executable function and the matching metadata item; wherein a first set of patterns remains; assigning a matching metadata item to one or more of the patterns in the first set; and selecting a pattern among first set of patterns and executing the function named in the selected predefined pattern with assigned metadata.

Thereby the user is given an option of taking different optional actions on data at a point in time where the data are yet not retrieved. Thereby the business intelligence software application accepts both different executable functions and different metadata as input in the same user dialogue. The business intelligence software application thereby supports different actions be taken on data at the very first time the data are requested. This saves the user from dealing with prolonged step-by-step user dialogues with the software application. Thus the user can directly, in a very first user dialogue, obtain the result (s)he is after. For instance in connection with user interfaces on a mobile device such as a so-called tablet computer, a smart phone or the like, it is expedient in this way to avoid many steps in a user dialogue. Thus, the claimed method is very expedient for mobile devices.

Also it is secured that a user has a greater freedom in phrasing what (s)he wants to do with requested data. Examples of what a user can ask for at this first instance of user interaction is to request not only an analysis or a report, but also to request an early warning of some alarming condition being met in the data, a scheduled delivery of a report or a video sequence of different data views. The software application responds to such requests by identifying and running respective executable functions taking identified metadata as input. This flexible way of getting directly to the result the user is after saves valuable time for the user.

The predefined patterns of named executable functions with their parameters, type of metadata, i.e. their formal syntax, define a paradigm for capturing a user's possibly disarrayed input elements into an ordered structure. This relieves the user from recalling a specific syntax and gives the user a smooth and quick way to get to a desired end-result.

Named executable functions are programmed functions configured to receive a metadata item as its input, retrieve data defined by the metadata item from a database and output a result of processing the data. The functions are respectively programmed to process the data by preparing an analysis, a report, a warning of some alarming condition being met in the data, a scheduled delivery of a report or a video sequence of different data views. These functions are selectively invoked by the user right from the first point of a user's interaction with the software application to request data.

As examples, the functions could be named ‘report’, ‘analysis’, ‘storyboard’, ‘notify’ and ‘schedule’, respectively. The functions take one or more parameters as input in the form of named metadata item, which could be a metadata item in the form of a measure denoted ‘Sales’ and a dimension denoted ‘time’ and/or it could be a criterion stating that time is limited to year 2013. The functions retrieve data defined by said named metadata item from a database and outputs in some way a visual presentation of said data.

In general, metadata are data that describes other data. In the context of multidimensional databases, so-called ‘measures’ are a class of data containing measured values, whereas so-called dimensions are a class of data containing divisions of typically time or some predefined structure. Criteria defining a limit or a range of data or data values are also metadata. Formatting properties for visual presentations are also metadata. Thus, metadata can define which data to retrieve and how to present them. Metadata may thus remain unchanged while the data are updated on a running basis.

The set of predefined patterns of named executable functions and formal syntax can be represented in software in various ways, e.g. by expanding all combinations of executable functions in formal syntax, wherein metadata parameters are represented by parameter names. For instance, a single function named ‘analyze’ may be expanded to the following predefined patterns:

“analyze mmm”
“analyze mmm ddd”
“analyze mmm ddd ccc”
“analyze mmm ccc”

Where ‘mmm’ designates a metadata item of the measures type, ‘ddd’ designates a metadata item of the dimensions type, and ‘ccc’ designates a metadata item that is a criterion. Once the name and type of the identified metadata items is determined, it can be assigned to a best matching pattern.

This pattern may be selected and executed by executing the function named in the selected predefined pattern with assigned metadata.

The step of listening for a user's input is performed e.g. by processing so-called events raised by the computer's operating system. Such an event may be processed each time a character is entered via a keyboard or each time a speech recognition system outputs a recognised word or syllable.

In some embodiments, the steps of selecting a pattern among first set of patterns and executing the function named in the selected predefined pattern with assigned metadata are performed upon completing a step of identifying a termination of user input. Thereby, a pause in a user's input may trigger that input already given by the user is processed according to the method.

In some embodiments the step of assigning a matching metadata item to one or more matching executable functions assigns a matching metadata item, of an identified type, firstly mentioned in the input to a firstly selected field requiring the identified type of metadata item. However, other predefined ways of assigning metadata may be feasible.

In this way the user may present the input in a random order, with an informal syntax, which may be reorganised by the assigning step to properly fit with the formal syntax. Also, in this way superfluous input elements are ignored. In some embodiments superfluous input to be ignored are those input elements that are not recognised as executable functions or metadata. Superfluous input elements may be input elements that are not recognised among the metadata items or among predefined patterns.

In some embodiments the firstly selected field is the field of the identified type firstly occurring in the syntax, where the syntax comprises ordered fields.

In some embodiments the step of searching for matching metadata items is performed: in a first step of searching a first storage section storing a complete set of named metadata items wherein each named metadata item is unique in the complete set, and/or in a second step of searching a second storage section storing multiple documents each containing a collection metadata items comprising at least a measure, a dimension and a formatting item.

The first step searches for individual metadata items and enables the user to combine metadata items freely. This search is convenient since metadata can be correctly recognised and their type determined before a formal query is formed and submitted to a database.

The second step searches for a collection of metadata items in documents. In this way a metadata item input can be as a key to collections of metadata items comprising the metadata item. If for instance a metadata item ‘sales’ is searched for, a document may be found comprising the metadata item ‘sales’ in combination with the dimension ‘time’ and another measures ‘costs’ in combination with the dimension ‘country’. Firstly, the measure ‘sales’ is combined with a dimension which makes it possible to complete an association of a measure and a dimension and then in turn to retrieve data for a first graph or other type of presentation. Secondly, a further association is found with the measure ‘costs’ and the dimension ‘country’. Thus, inputting only a single measure reveals a document comprising four measures defined in combination in a document. Further, it is noted that the metadata item reveals a document defining two presentations along the two dimensions ‘time’ and ‘country’. The document may also comprise formatting metadata and criteria.

Documents are stored e.g. when a user has defined it. In some embodiments documents are defined according to the eXtendend Markup Language, XML. The software application is configured to provide the user with graphical user interface tools for defining the metadata stored in a document.

In some embodiments the method comprises rendering a document comprising multiple sets of metadata items to provide visualisation of multiple sets of data.

In some embodiments the step of executing the function named in the selected predefined pattern with its assigned metadata is performed: in a first option, where metadata are retrieved from the input and from documents, or in a second option, where metadata are determined from the input and where content in documents is disregarded; comprising presenting to the user, via the user interface, a selectable choice between the first option or the second option.

In this way the user can intervene and decide whether to use a stored document or not. In the latter case, allowing the user to freely define a new combination of metadata. The first option may be implemented by showing a list of stored documents revealed by search to the user. In some embodiments the list of documents is configured with links to the documents.

In some embodiments the method comprises determining at least one association, of a dimension and a measure, by combination of a measure and dimension identified in the user's input, or by addition of a dimension or measure to an identified measure or dimension, respectively.

The association thus comprises a measure and a dimension which is sufficient for retrieving a set of data. In case the user omits to input both a measure and a dimension, but inputs only one of them, the software application performs a search to identify a stored association, e.g. stored in a document, which comprises the input measure or dimension, as the case may be. The other portion of the association can then be determined by selecting e.g. the dimension or measure most frequently used in combination with the respective measure or dimension that was given in the input. It is therefore convenient when a document or an association is stored with a count of use and that this count is updated when this association is used in connection with an action or when a document containing this association is loaded or stored.

A document may comprise multiple associations. The above step of determining an association may also comprise determining other of those associations that are stored in a document.

In some embodiments the method comprises: computing a linguistic distance between an input element and an executable function or a named metadata item; and comparing the linguistic distance to a threshold to decide whether there is a match.

In some embodiments the linguistic distance is computed as the so-called Levenstein distance. Experiments have shown that a threshold of about 60-70% match allows a good trade-off between matching what the user is after and avoiding catching another executable function or another metadata item. As an example, this threshold makes it possible to match the executable function ‘analyze’ despite the user inputs the element ‘analysis’. Other algorithms for computing the linguistic distance may be used.

In some embodiments the software application comprises a data structure with a group of synonyms for a respective, named metadata item or a named executable function; and wherein: the processing of said input comprises identifying an input elements by looking up the group of synonyms and identifying the input element as the respective, named metadata item or a named executable function.

The group of synonyms comprises a list of synonyms or alternative names for a named metadata item or a named executable function. Receiving a user's input, looking up the group of synonyms, and in case the user's input is found among the synonyms, taking the respective, named metadata item or a named executable function as an identified input element expands the likelihood of capturing the user's input and provide an appropriate response. It is observed that this step greatly enhances the user experience. The user is more likely to get a desired result, despite being less experienced with databases.

In some embodiments the method comprises computing a linguistic distance between an input element and at least one of the synonyms, comparing the linguistic distance to a threshold to decide whether there is a match, and in the affirmative event: identifying the input element as the respective, named metadata item or a named executable function.

The steps of computing a linguistic distance and comparing to a threshold make the software application more tolerant to typos and spelling mistakes in the user's input. Combining these steps with a list of synonyms further improves the likelihood of catching the user's input.

In some embodiments the method comprises the step of identifying which types of metadata items in the syntax pattern that remains unassigned and providing an input element for an unassigned field by: assigning a default value to the parameter or type of metadata; or prompting a user to input a value for an unassigned field.

There is also provided a data processing system having stored thereon program code means adapted to cause the data processing system to perform the steps of the above method when said program codes means are executed on the data processing system.

There is also provided a computer program product comprising program code means adapted to cause a data processing system to perform the steps of the method when said program code means are executed on the data processing system.

In some embodiments the software application comprises: a user interface configured to receive a user's input in sequential form; named executable functions that are configured to: receive a parameter in the form of a named metadata item; retrieve data defined by said named metadata item from a database; and output a result of processing the data; and a set of predefined patterns of named executable functions and their formal syntax, and a set of named metadata items.

### DESCRIPTION OF THE FIGURES

A more detailed description follows below with reference to the drawing, in which:

FIG. 1 shows a flowchart for processing an input via a user interface of a business intelligence software application;

FIG. 2 shows a first portion of a user interface of a business intelligence software application;

FIG. 3 shows a second portion of a user interface of a business intelligence software application;

FIG. 4 shows a flowchart for a method of processing metadata; and

FIG. 5 shows a flowchart for a method of retrieving data from metadata.

### DETAILED DESCRIPTION

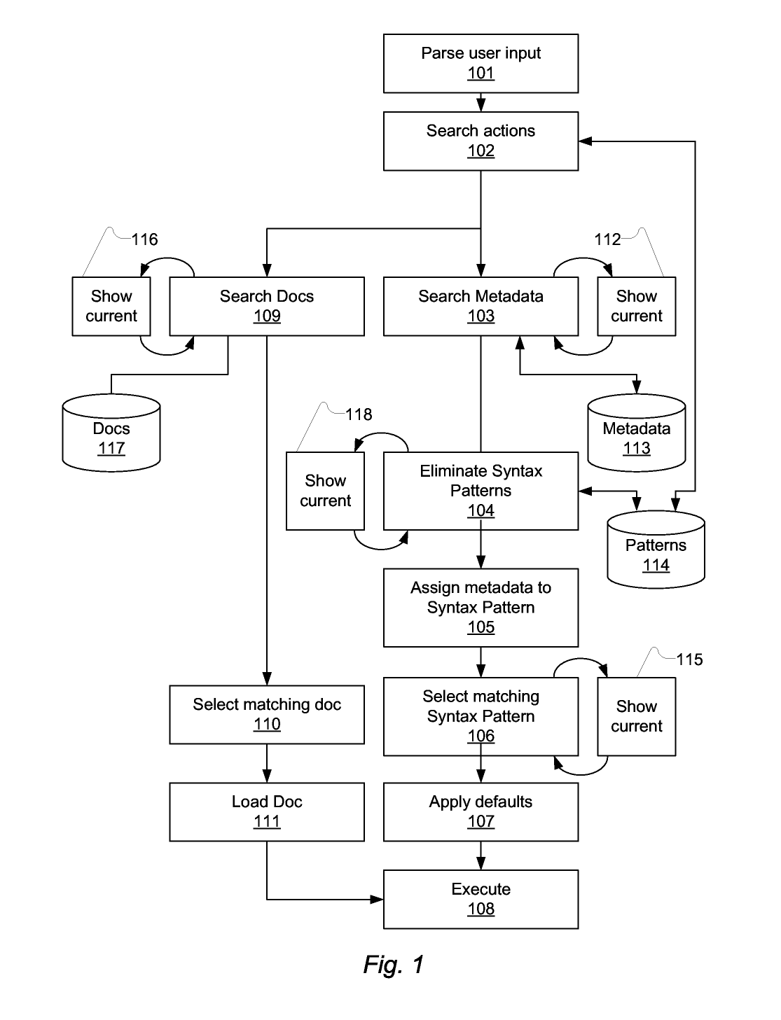

FIG. 1 shows a flowchart for processing an input via a user interface of a business intelligence software application. The software application comprises a user interface configured to receive a user's input in sequential form; a collection of named executable functions, also denoted actions, a set of predefined syntax patterns of named executable functions with respective parameters, and a set of named metadata items.

The user's input can be received via a so-called textbox input in which the user types in a text input character-by-character via a keyboard or via a speech processor configured to receive a user's spoken input. In general the user's input is given in form of one or more input elements which may be letters (characters), words e.g. commands or items, terms, numbers or fractions thereof e.g. syllables. Input element is the general term. The phrase ‘in sequential form’ means that input elements are received one after each other.

The business intelligence software application offers a multitude of executable functions or actions which the user can have executed via the user interface by giving his input as described above. In some embodiments the business intelligence software application has those executable functions embedded in program code or libraries or has an interface for accessing the executable functions remotely e.g. as a so-called web-service. The executable functions are configured to receive a parameter e.g. in the form of a named metadata item; retrieve data defined by said named metadata item from a database; and output a result of processing the data. Thereby the user is given an option of taking different optional actions on data at a point in time where the data are yet not retrieved. This option saves the user from making many tedious user interactions, typically via a wizard like guidance involving a multitude of mouse-clicks on a graphical user interface. In some embodiments the executable functions are configured to create:
an on-screen analysis showing one or more graphs or other data presentations for graphical user interaction,
a report for a printed media,
a so-called dashboard,
a so-called storyboard with a video rendering of data presentations;
a scheduled delivery of a report, a dashboard, or a storyboard, or
a warning, triggering any of the above functions in case a predefined criterion is met.

The different executable functions process the data defined by metadata input by the user in respective ways. The different executable functions provide their output at respective destinations e.g. in a data structure of a graphical user interface, in a report, in a video, in a message object e.g. an email object, or to a data transport interface for a remote data system. Processing of the data may comprise graphical rendering, statistical signal processing or other types of processing. Functions for providing a dashboard or a storyboard are described in more detail in the applicant's US patent applications US 2009/187845 and US 2008/301539, which are herewith incorporated by reference for everything they disclose.

Reverting to the flowchart, the business intelligence software application performs a method of processing a user's input received via the user interface. In step 101 the method listens for a user's input and processes the input while it is received to identify input elements thereof. This is performed by parsing the user's input. As a result thereof input elements in the user's input are identified. Listening for a user's input can be implemented in various ways e.g. by so-called event-listeners, wherein an event is raised when input is given. As an example a user may enter the text: “give me a revenue analysis”. This input is parsed and output is given in multiple input elements: {give}, {me}, {a}, {revenue} and {analysis}. In some embodiments input elements are separated by a space-character or a temporal pause. A filter may remove input elements such as ‘give’, ‘me’ and ‘a’. Such words may be removed or ignored if they are comprised by a predefined set of so-called stop-words. Stop-words may also be defined as words that are not included by a list of accepted words that comprises predefined names of metadata, names of actions, and other commands or instructions for the software application.

Then in step 102 a search for actions or executable functions is performed. The search is performed in storage memory 114 wherein a set of syntax patterns is stored. An exemplary set of syntax patterns is shown in table 1 below:

TABLE 1
Syntax patterns

| | |
|---|---|
| 1 | analyze mmm |
| 2 | analyze mmm grouped by ddd |
| 3 | analyze mmm grouped by ddd selected by ccc |
| 4 | analyze mmm selected by ccc |
| 5 | report fff |
| 6 | report fff grouped by ddd |
| 7 | report fff grouped by ddd selected by ccc |
| 8 | report fff selected by ccc |
| 9 | dashboard showing mmm |
| 10 | dashboard mmm ddd |
| 11 | dashboard mmm ddd selected by ccc |
| 12 | storyboard fff |

The syntax patterns comprise syntactically valid combinations of named executable functions and parameters comprising different types of metadata. The executable functions named ‘analyze’ and ‘report’ are included in four respective syntax patterns. The functions ‘dashboard’ and ‘storyboard’ are included in three and one syntax patterns, respectively. The syntax patterns represent parameters for the actions by means of codes like ‘mmm’ and ‘ddd’ representing metadata items of the type measures and dimensions, respectively. Some actions may accept more parameters than shown above, e.g. the action ‘analyze’ may accept multiple parameters of the measures type. For an implementation of the method such a complete set of syntax patterns is stored.

Continuing the above example, {revenue} and {analysis} remains as input items after removal of stopwords. The search for actions in step 102 then reveals that {revenue} was not identified as an action, but that {analysis} is identified as a action. The input element {revenue} was not identified in step 102, but it is then subject for a search for metadata in step 103. The search is performed in metadata storage memory 113, which comprise a list of metadata items with an indication of their metadata type. Metadata storage memory 113 may e.g. comprise the items {revenue}, {cost}, and {profit} of the measures type and the items {time}, {countries} of the dimension type. Additionally, the metadata storage memory 113 may comprise metadata items with formatting properties for graphs or other types of presentations. The measure, dimension and formatting type of metadata may be indicated by ‘mmm’, ‘ddd’ and ‘fff’. Thereby, the input element {revenue} can be identified as a measure by the code ‘mmm’. By means of step 112 a current assessment of identified metadata items and actions may be shown to the user via the user interface, e.g. by listing the items {analyze} and {revenue} with a checkmark. Thereby the user is notified that the elements are identified or recognised.

In the following step 104, those syntax patterns that do not comprise the matching executable function and the matching metadata item are eliminated from a full set of syntax patterns. Step 104 may be started already after step 102. Once the action ‘analyze’ is recognised, patterns 5 through 12 of the above 12 patterns can be eliminated from further search on the input element given by the user. Patterns 1 through 4 remain since they contain the action ‘analyze’. The result of the search for metadata is then taken into account, and the identified metadata item {revenue} is assigned as a parameter for the function {analyze} in step 105. In some embodiments, the step of assigning a metadata item to one or more matching executable functions assigns a matching metadata item from step 103, of an identified type, firstly mentioned in the input to a firstly selected field requiring the identified type of metadata item.

In connection with step 104, those patterns that are not eliminated may be shown to the user by step 118 (i.e. patterns 1 through 4 above). In other embodiments the user interface shows to the user that the action ‘analyze’ can be executed since at least one of the patterns (pattern 1 above) is completely assigned with metadata.

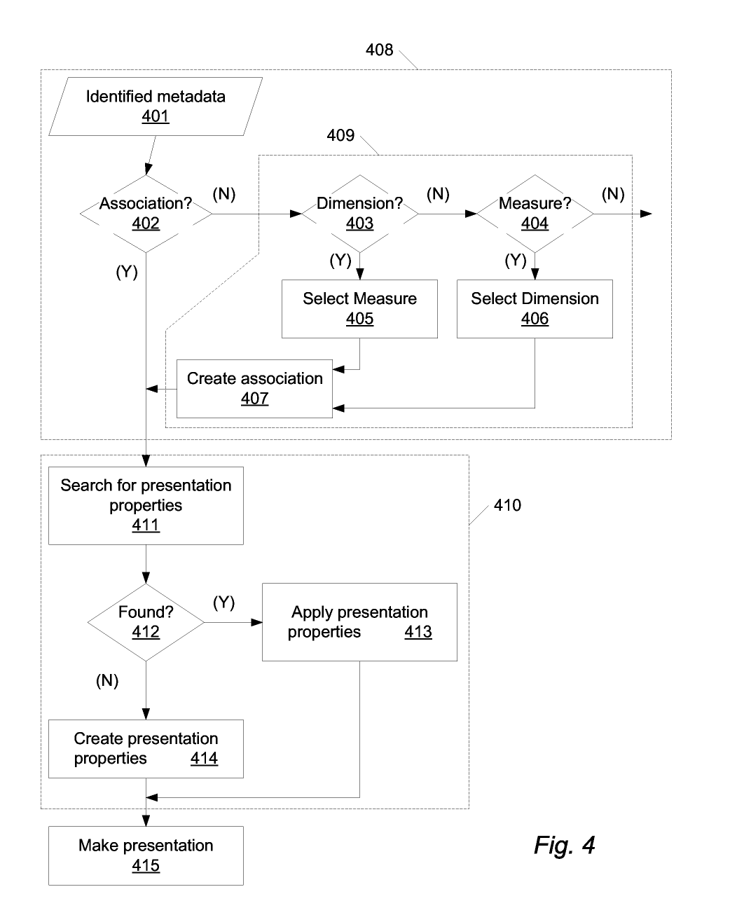

In some embodiments the method identifies that a user has stopped entering or giving input and a pattern with all parameters assigned to a value is automatically selected for being executed. Alternatively, in step 107, the method assigns default values to parameters that remained unassigned. Some actions may have parameters assigned to them that are hidden from the user at least at this stage of user interaction and that per default is assigned with default parameters. Default parameters may be retrieved in a context sensitive manner and/or according to a frequency of use. This is described in more detail below in connection with FIG. 4.

In some embodiments actions and metadata items are stored in documents, which are searched in step 109. Step 109 may be entered once the search for actions in step 102 has revealed that at least one action is identified or that a predefined category of an action is identified. Documents are stored in document storage memory 117. Typically, documents comprise collections of metadata items comprising one or more associations of a dimension type metadata item and a measure type metadata item and formatting type metadata e.g. specifying a graph type and properties thereof. Typically, a document contains the information that would have been applied in step 107 in case the user (or the software application) selected an action. A document can comprise a collection of graph objects or other types of presentations with its data content specified by means of metadata.

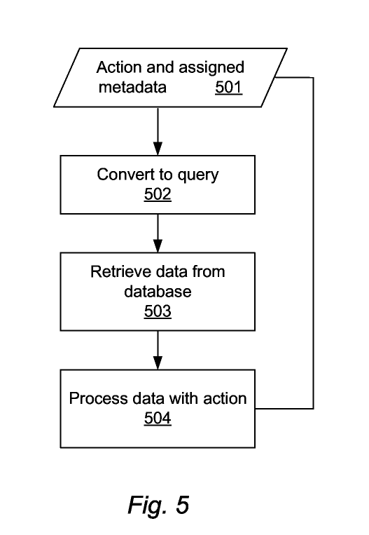

Documents revealed by the search may be listed for the user to select one or more of them; a selected one is loaded in step 111 and executed in step 108. Execution of actions or documents comprises querying a database to retrieve and render a presentation of the data defined by the metadata items. This is described in more detail below in connection with FIG. 5.

In case the user inputs either a measure or a dimension, but fails to input both a measure and a dimension the step of applying defaults may comprise a step of creating an association comprising both a measure and a dimension. This is explained in greater detail in the below in connection with FIG. 4.

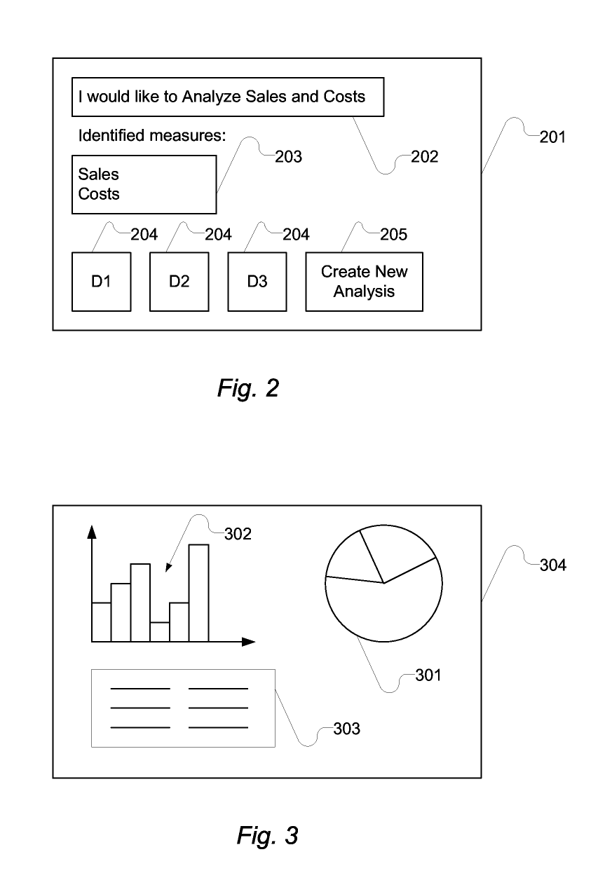

FIG. 2 shows a first portion of a user interface of a business intelligence software application. The user interface is shown in a simple form with a user interface window 201 comprising a textbox input 202.

The user can give an input in a textual form phrasing what (s)he would like the business intelligence software application to do for her/him e.g. writing: “give me a revenue analysis” or “I would like to analyze sales and costs”. Processing of the input is performed as described above.

The textbox 203 shows metadata items of the measures type or dimensions type as they are identified in the user's input. The metadata items in textbox 203 are shown by means of step 112 as described above.

Once an action is identified in the user's input, a button 205 is enabled or shown on the user interface. A user's activation of the button makes the method proceed to execute the designated action with the measures listed in the textbox 203 as its parameters. In this way the user selects a predefined syntax pattern comprising the action and the identified measures.

The result of the search for documents may be shown by graphical buttons 204 designating titles of the documents revealed by the search e.g. designated “D1”, “D2” and “D3”. By pressing a button the user can select a respective document for execution.

FIG. 3 shows a second portion of a user interface of a business intelligence software application. The first portion of the user interface, shown in FIG. 2, is configured to receive a user's input and to give the user feedback on identified metadata items and documents. The second portion, shown in FIG. 3, is configured to display the result of executing an action outputting a visual presentation output from an action.

In the shown example, the user interface displays three presentation objects in the form of a so-called piechart 301, a barchart 302 and a table 303. The second portion 304 of the user interface is displayed as a result of executing a document or executing an action in connection with step 108 described above. The presentation objects or the user interface may comprise controls (not shown) configured to adjust or change properties of the presentation objects e.g. to change the type of the presentation object, its colour properties, font type for text matter with the object etc. as it is known in the art. For textual presentations the objects may comprise text sections, headings, tables with columns and rows, etc. The formatting metadata, also denoted properties, may comprise font size, line spacing, etc. For graphical presentations the means may comprise different types of charts and diagrams such as bar charts, line charts, pie charts, scatter charts, radar diagrams and other known diagrams or charts based on graphical elements. The properties may comprise tick marker spacing on an axis, legend font size, etc.

The user interface can handle different situations. In a first situation, a user can give his input by means of the first portion of the user interface as described above, whereas in a second situation a user can request further data by an action directed directly to a presentation object to thereby explore data by further analysis. This is described in more detail in connection with the applicant's U.S. Pat. No. 7,949,674 and U.S. Pat. No. 8,468,444 which are hereby incorporated by reference for everything they disclose.

FIG. 4 shows a flowchart for a method of processing metadata. The processing of metadata comprises determining an association and determining a presentation. The method of processing metadata may be performed in connection with step 107 wherein defaults are applied. Defaults are parameter values that the user has not explicitly specified in a present input, but values may be retrieved by some type of expert system as exemplified by the flowchart. Default values may be predefined values comprising values programmatically entered in the software application or values previously selected by a user. In some embodiments, first time a user gives a certain input, values programmatically entered in the software application are applied. Then he adjusts metadata e.g. via the second portion of the user interface and stores the result in a document. A second time the user gives the same certain or a similar input, default values may be retrieved from such a document. In some embodiments default values are stored in a dedicated storage memory of previously used combinations of metadata and presentation properties and/or other parameters.

The contents of such a storage memory with previously used combinations of metadata and presentation properties can have the following form as shown in table 2 below:

TABLE 2

| Data | Presentation | Frequency |
|---|---|---|
| Time, Level 1 | type=Barchart; legend=off; | 3 |
| Revenue | labels=off; 3D- | |
| | effects=Orthogonal | |
| Country; | type=map; legend=off; | 3 |
| Contribution Margin | labels=on; 3D-effects=None | |
| Customer, Level 0; | Type=Crosstab; legend=off; | 2 |
| Revenue; | labels=off; 3D-effects=None | |
| Cost; | | |
| Contribution Margin | | |
| . . . | . . . | . . . |

By searching the storage memory, with contents e.g. as shown in table 2 above for default values, it is possible to determine whether a previous action has been used. Thereby a user's preferred presentation properties can be found. If for instance it is determined that a question involves the data item ‘time, level 1’ and ‘revenue’, it can be deduced that the preferred presentation of these data items is a bar chart with properties as shown in table 2 above.

The flowchart is divided into a data determining section 408, a presentation determining section 410 and a step 415 of making a presentation based on determined data and presentation properties. In case an action does not provide a graphical presentation output, the method may skip the presentation determining section 410 i.e. the method may terminate when steps of the data determining section 408 have been performed.

In the data determining section 408, metadata 401 identified in step 103 are input. That is, the metadata and their category and associations of data items, if any, are input. Optionally, the metadata 401 can comprise an identification of dimension levels; criteria, if any; and combinations of associations. In step 402 it is determined whether any associations were identified. In the positive event (Y) it can prima facia be deduced that sufficient data were present in the question and that a search for presentation properties can be initiated in step 411. In the negative event (N) however, it can be deduced no association is found in the representation of the input metadata and according to the invention the method continues in section 409 of the flowchart to create an association. In section 409 it is examined in step 403 whether an identified data item is of the dimensions type. In the positive event (Y) of step 403 a data item of the measures type is selected in step 405. In the negative event (N) of step 403 it is examined in step 404 whether an identified data item is of the measures type; and in the positive event (Y) thereof a data item of the dimensions type is selected in step 406. In case no measure is identified, and consequently no dimension is identified, it can be deduced that the input metadata has not even incomplete information, but is lacking information. In this case the situation can be handled by prompting the user to enter valid input metadata with at least one data item or alternatively by applying the most frequently used metadata and therewith applied presentation properties.

In steps 405 and step 406 a previously used association, if any, involving the identified data item may be detected. However, in the event no previously used association involving the data item is found, a most frequently used data item can be selected or all data items of the respective type can be selected. An association based on the identified data items and determined data items is created in step 407. This step can involve creating a memory object for each data item of the dimensions type.

If a data item of the measures type or dimensions type has been selected in either step 405 or step 406, respectively, a search for presentation properties can in a storage memory be initiated in step 411. In step 412 it is examined whether a previously used presentation is found. In the positive event (Y) presentation properties of a previously stored, like association is found, the presentation properties are applied in step 413 to make a presentation of the data specified by the association in step 415. Alternatively (N), if no like association is found, presentation properties are created either by selecting the association that is most like an existing association and/or by using an expert system. Consequently, even a question with incomplete data identification can lead to retrieval and application of preferred presentation properties to make a presentation.

In some embodiments, the method according to the invention can simply parse the input metadata to identify associations, and subsequently proceed directly to step 411 to search for presentation properties. Thereby, presentation properties can be retrieved based on associations identified in the input metadata. Thus the steps 402 and steps in section 409 can be omitted while the method is in accordance with the invention.

Thus, a dimension or measure as the case may be can be selected to create a complete association. Also, an identified association, dimension or measure can be expanded to multiple associations.

The expanding can be based on user preferences. User preferences can be determined by maintaining a list of combinations of associations that are used concurrently or in the same data report. Thus, when an association is determined it can be expanded by looking up other associations which have previously been used in combination with the identified association.

Alternatively, the list can include a number which for an identified association reflects the likelihood that a user will apply another identified association. This number can be a relative or absolute number of times the identified association has previously been used in combination with the other identified association. Thus, when an association is determined it can be expanded by looking up other associations which, with a given likelihood, have been used in combination with the identified association. For instance, the given likelihood can be expressed as a threshold value of e.g. 50%; for an association A1 it is stated that in 10% of its uses association A2 is also used, whereas in 90% of its uses association A3 is also used. Thus it can be deduced that A1 should be expanded to be combined with A3.

When a measure is identified, firstly, a complete association is created by selecting a dimension. Secondly, this created association can be expanded as set forth above. This also applies to dimensions.

The aspect of expanding an association from an identified association and/or measure and/or dimension can be embodied as an individual step between section 408 and 410. Alternatively, the aspect can be embodied by means of section 410. In any event, when an association is expanded presentation properties is to be applied to make a presentation of the multiple associations obtained by expanding an identified association.

It should be noted that step 402 can be applied iteratively to identify multiple associations and/or measures and/or dimensions in the metadata.

FIG. 5 shows a flowchart for a method of retrieving data from metadata. As mentioned above, the executable functions or actions are configured to receive a parameter in the form of a named metadata item; retrieve data defined by said named metadata item from a database; and output a result of processing the data.

As a result of assigning metadata in step 105 and applying defaults in step 107 or as a result of loading a document in step 111 the action(s) can be executed in step 108. As a step thereof, data are retrieved from a database using the metadata. Sometimes data are also denoted underlying data to more clearly distinguish the data that are retrieved from metadata.

As a step of executing the action in step 108, an action and assigned metadata 501, are converted to a query to retrieve data from a database in step 502. In step 503 the data are retrieved from the database and in step 504 the data are processed according to programme steps defined in a selected action.

In an exemplary embodiment the database contains the following data items, wherein the date items are categorized as measures or dimensions and wherein a dimension exists at different levels such as day, month, and year:

TABLE 3

| Measures: | Dimensions: |
|---|---|
| ‘revenue’ | ‘time’ (level 0: Year; level 1: Month; level 2: Day) |
| ‘cost’ | ‘Customer’ (level 0: Group; level 1: Name) |
| | ‘Product’ (level 0: group; level 1: Name) |
| | ‘Country’ |

In the above example, the measures ‘revenue’ and ‘cost’ contains data, underlying data, along the different dimensions. A data set is defined by specifying both a measure and a dimension. For instance, the association of the measure ‘revenue’ and ‘country’ defines a data set where ‘revenue’ is represented by means of data values per ‘country’ as they may be defined in the database.

Generally, and in connection with the present invention, it should be noted that a dimension is a collection of data of the same type; it allows one to structure a multidimensional database. A multidimensional database is typically defined as a database with at least three independent dimensions. Measures are data structured by dimensions. In a measure, each cell of data is associated with one single position in a dimension.

The term OLAP designates a category of applications and technologies that allow the collection, storage, manipulation and reproduction of multidimensional data, with the goal of analysis.

Special modules may be provided to transform operational data from a source database or transaction database to analytical data in a data warehouse. In some situations it may be inconvenient to transform the operational data to analytical data which are stored in another database. Therefore the operational database, which is typically a relational database, can be emulated such that it is exposes an interface from which the operational database appears and is accessible as a multidimensional database.

In the above, the term database can designate any type of database whether analytical or transactional.

1. A computer-implemented method of processing an input via a user interface of a business intelligence software application, wherein the software applications performs:
listening for a user's input, and processing said input while it is received to identify input elements thereof; said input elements comprising at least a first and second input element;
searching among predefined named executable functions for a matching executable function that match the first identified input element;
searching in a predefined set of named metadata items for a matching metadata item that match the second identified input element;
eliminating, from a set of syntax patterns with syntactically valid combinations of named executable functions and types of metadata, patterns that do not comprise the matching executable function and the matching metadata item; wherein a first set of patterns remains;
assigning a matching metadata item to one or more of the patterns in the first set;
selecting a pattern among first set of patterns and executing the function named in the selected predefined pattern with assigned metadata.

2. A computer-implemented method according to claim 1,
wherein the step of assigning a matching metadata item to one or more matching executable functions assigns a matching metadata item, of an identified type, firstly mentioned in the input to a firstly selected field requiring the identified type of metadata item.

3. A computer-implemented method according to claim 1, wherein the step of searching for matching metadata items is performed:
in a first step of searching a first storage section storing a complete set of named metadata items wherein each named metadata item is unique in the complete set, and/or
in a second step of searching a second storage section storing multiple documents each containing a collection metadata items comprising at least a measure, a dimension and a formatting item.

4. A computer-implemented method according to claim 3, wherein a document comprising multiple sets of metadata items is rendered to provide visualisation of multiple sets of data.

5. A computer-implemented method according to claim 3, wherein the step of executing the function named in the selected predefined pattern with its assigned metadata is performed:
in a first option, where metadata are retrieved from the input and from documents, or
in a second option, where metadata are determined from the input and where content in documents is disregarded;
comprising presenting to the user, via the user interface, a selectable choice between the first option or the second option.

6. A computer-implemented method according to claim 1, comprising:
determining at least one association, of a dimension and a measure, by combination of a measure and dimension identified in the user's input, or by addition of a dimension or measure to an identified measure or dimension, respectively.

7. A computer-implemented method according to claim 1, comprising:
computing a linguistic distance between an input element and an executable function or a named metadata item; and
comparing the linguistic distance to a threshold to decide whether there is a match.

8. A computer-implemented method according to claim 1, wherein the software application comprises a data structure with a group of synonyms for a respective, named metadata item or a named executable function; and wherein:
the processing of said input comprises identifying an input elements by looking up the group of synonyms and identifying the input element as the respective, named metadata item or a named executable function.

9. A computer-implemented method according to claim 1, comprising the step of identifying which types of metadata items in the syntax pattern that remains unassigned and providing an input element for an unassigned field by:
assigning a default value to the field; or
prompting a user to input a value for an unassigned field.

10. A data processing system having stored thereon program code means adapted to cause the data processing system to perform the steps of the method according to claim 1, when said program codes means are executed on the data processing system.

11. A computer program product comprising program code means adapted to cause a data processing system to perform the steps of the method according to claim 1, when said program code means are executed on the data processing system.

12. A computer program product according to claim 11, wherein the software application comprises:
a user interface configured to receive a user's input in sequential form;
named executable functions that are configured to:
receive a parameter in the form of a named metadata item;
retrieve data defined by said named metadata item from a database; and
output a result of processing the data; and
a set of predefined patterns of named executable functions and their formal syntax, and a set of named metadata items.
